(19) United States
(12) Patent Application Publication
(10) Pub. No.: US 2002/0075824 A1
(43) Pub. Date: Jun. 20, 2002

(54) System and method for distributing files in a wireless network infrastructure

(76) Inventors: Tom J. Willekes, Calgary (CA); Xiaobo Mei, Calgary (CA)

Correspondence Address: Bruce E. Garlick, Garlick & Harrison, P.O. Box 691, Spicewood, TX, 78669-0691, US

(21) Appl. No.: 09/737,143

(22) Filed: Dec. 14, 2000

(51) Int. Cl. H04Q 7/00

(52) U.S. Cl. 370/329; 370/390; 370/432

(57) ABSTRACT

A system of the present invention includes a server that distributes files to a plurality of receivers within a wireless communication system. The server and the plurality of receivers are components of the wireless communication system network infrastructure. In one embodiment, the server is a base station manager and the receivers are base stations. In operation, the sender establishes a multicast session with the plurality of receivers by interacting with the plurality of receivers. The sender subdivides the file(s) into a plurality of data packets and multicasts the plurality of data packets to the plurality of receivers. At least some of the plurality of receivers fails to receive some of the plurality of data packets. Receivers failing to receive some or all of the plurality of data packets error report to the sender of the file. The sender then retransmits a plurality of unreceived data packets of the plurality of data packets to the error-reporting receivers. According to one embodiment of the present invention, the base stations operate according to a code division multiple access wireless operating standard and the base stations load the file(s) onto a plurality of processing cards contained within the base stations. In such case, the base station may require a software update and the file(s) are the software update.

### BACKGROUND

1. Technical Field

The present invention relates generally to cellular wireless communication networks; and more particularly to the distribution of files within the cellular wireless communication network.

2. Related Art

Cellular wireless networks are generally known to include a “network infrastructure” that facilitates wireless communications with mobile stations operating within a respective service coverage area. The network infrastructure typically includes a plurality of base stations dispersed throughout the service coverage area, each of which supports wireless communications within a respective cell (or set of sectors). The base stations couple to base station controllers (BSCs), with each BSC serving a plurality of base stations. Each BSC couples to a mobile switching center (MSC), which also couples to the PSTN, the Internet and/or to other MSCs.

A wireless mobile station operating within the service coverage area wirelessly communicates with one or more of the base stations. The base stations route the communications to the serving MSC via a serving BSC. The MSC routes the communications to another subscribing wireless unit via a BSC/base station path (which may be the same BSC/base station path when the communications are with another subscribing unit serviced by the same base station) or via the PSTN/Internet/other network to terminating destination.

Various wireless interface standards have been developed to standardize wireless communications so that equipment of differing vendors may interface. Wireless interface standards include, for example, the Advanced Mobile Phone Service (AMPS) standards, the Global Standards for Mobility (GSM), the Code Division Multiple Access (CDMA) standards and the Time Division Multiple Access (TDMA) standards. These operating standards set forth the technical requirements that facilitate compatible operation between equipment of differing vendors. The network infrastructure may operate according to industry standards. However, because a single service provider typically selects network infrastructure components, the network infrastructure components often operate according to proprietary standards. Thus, standardization of operations among the components of the network infrastructure is not a requirement.

Most network infrastructures include a large number of components. In a CDMA network that services a metropolitan area such as the Dallas/Fort Worth service area, for example, will include hundreds of base stations and multiple BSCs. Each of these base stations includes a plurality of processing components, e.g., call element modules, etc., that each performs call-processing operations. The components of the base station, and in particular, each of these processing components must be loaded with software and/or reprogrammed with software updates. The software is typically downloaded from a central location such as a Base Station Manager (BSM) that is intercoupled to the BSCs via a packet switched network.

According to a prior technique for downloading software to the base stations, the BSM downloads software to each base station separately. In an operation of this type, the BSM establishes a session with the base station and downloads the software update to the base station. The base station then either loads the software into its local storage or replicates the software and loads the software into a plurality of its processing components. Once this particular action is complete, the BSM establishes a session with another base station and downloads the software to the base station. This process is repeated until the software has been downloaded to all of the base stations. This process, unfortunately, consumes significant bandwidth of the network interconnecting the BSM to the base stations and significant BSM CPU bandwidth. Further, it is tedious and prone to error.

Because literally thousands of copies of files containing software must be downloaded from the BSM to the base stations, updating software in the base stations often overloads the network infrastructure and has a significant cost. Thus, software updates are only performed infrequently, at best. Thus, improvements to existing software are typically only made in large groups. Resultantly, improvements to the software run by the base stations, or other system components, are slowly deployed within the system and the benefits that would be derived from the software updates are slow to be implemented.

Other network components, such as the BSCs also require software updates. The updating of the BSCs also is costly and slow. Thus, updates to the BSCs' software are also performed only infrequently.

Thus, there is a need in the art for a system and method that may be employed to distribute software efficiently to the network components of a wireless communication system.

### SUMMARY OF THE INVENTION

Thus, to overcome the shortcomings of the prior systems, among other shortcomings, a system of the present invention includes a server that distributes files to a plurality of receivers within a wireless communication system. The server and the plurality of receivers are components of the wireless communication system network infrastructure. In one embodiment, the server is a base station manager and the receivers are base stations.

In an operation according to the present invention, a set of files is to be distributed to the receivers. For each of the files, the sender establishes a multicast session with the plurality of receivers by interacting with the plurality of receivers. The sender subdivides the file(s) into a plurality of data packets and multicasts the plurality of data packets to the plurality of receivers.

Because of errors in data packet transmission, at least some of the plurality of receivers fails to receive some of the plurality of data packets. Receivers failing to receive some of the plurality of data packets error report such failure to the sender. The sender then retransmits a plurality of unreceived data packets of the plurality of data packets to the error-reporting receivers in a sub-session. An error detection is then performed for this sub-session. If all errors have not been remedied for the sub-session, additional sub-sessions may be performed. The session is complete when all receivers have reported full receipt of the file.

After the first session is completed, an additional session is initiated and completed for each of the files that make up the set of files. Error detection is performed for each session until all files of the set of files have been distributed to the receivers. Then, the operation of the present invention is complete.

According to one embodiment of the present invention, the base stations operate according to a code division multiple access wireless operating standard and the base stations load the file(s) onto a plurality of processing cards contained within the base stations. In such case, the base station may require a software update and the file(s) are the software update.

In performing error reporting, the sender transmits an error status request to the plurality of receivers and all of the plurality of receivers responds to the sender with either an error message or a success indication. To avoid overloading the sender with responses, in one embodiment, the sender requests an error status report from its first plurality of receivers during a first time period and requests an error status report from its second plurality of receivers during a second time period. The receivers therefore respond in differing time periods because the first time period corresponding to the first plurality of receivers is different from the second time period corresponding to the second plurality of receivers.

According to the present invention, not all of the receivers are to receive each of the files that make up the set of files. Thus, each session may have a particular corresponding set of receivers. During session initiation, the sender initializes those receivers that are to receive the file corresponding to the session. Session initiation forms groups of clients using a fine granularity mechanism, as does sub-session initiation. Fine granularity group control uses a bit vector mechanism to represent precise membership within groups for the sake of determining the specific clients that should join the session.

For error detection, a coarse group control mechanism is used to prevent feedback implosion (whereby a large number of receivers overload the sender). The coarse mechanism decomposes the set of receivers into groups by using pseudo-random numbers in clients.

With the operations of the present invention (in particular group control mechanisms), any number of receivers may be included. Thus, the system and operations of the present invention provide great benefits in their scalability. Further, because of the error detection and correction of the present invention, the file distribution performed by the present invention is extremely reliable. Such reliability is an absolute requirement when deploying software and data within a wireless communication system.

Moreover, other aspects of the present invention will become apparent with further reference to the drawings and specification, which follow.

### BRIEF DESCRIPTION OF THE DRAWINGS

A better understanding of the present invention can be obtained when the following detailed description of the preferred embodiment is considered in conjunction with the following drawings, in which:

FIG. 1 is a system diagram illustrating a portion of a cellular wireless communication system in which the present invention is employed to distribute software to network infrastructure elements;

FIG. 2 is a logic diagram generally illustrating operation according to the present invention;

FIG. 3 is a block diagram illustrating how the functional components of software protocols constructed according to the present invention reside within the OSI (Open Systems Interconnect) reference model;

FIG. 4 is a message flow diagram illustrating operation according to the present invention;

FIG. 5 is a logic diagram illustrating error correction operations according to the present invention;

FIG. 6 is a block diagram illustrating the components of a base station controller (BSC) that operates according to the present invention as a sender;

FIG. 7 is a block diagram illustrating the components of a base station manager that operates according to the present invention as a sender;

FIG. 8 is a block diagram illustrating the components of a base station that operates according to the present invention as a receiver;

FIG. 9 is a logic diagram illustrating the interaction of RMDP server components according to the present invention; and

FIG. 10 is a logic diagram illustrating the interaction of RMDP client components according to the present invention.

### TERMINOLOGY AND ACRONYMS

The following terminology is used to describe the system and method of the present invention:

Sender (or source node): A sender is a wireless network infrastructure component that is the originator of multicast data packets that make up at least one file. The sender is often responsible for supplying retransmissions in response to error correction requests.

Receiver (or end node): A receiver is a wireless network infrastructure component that receives multicast data packets that make up at least one file. Generally, a receiver is a full participant in a session but has no responsibilities to transmit data packets. Thus, receivers, unless otherwise noted, do not forward or supply retransmissions to other receivers.

RMDP server: A Reliable Multicast Distribution Protocol (RMDP) server is a software protocol set operating upon a sender that operates to distribute file(s) to a plurality of RMDP clients operating upon a plurality of receivers.

RMDP client: An RMDP client is a software protocol set operating upon a receiver that interacts with an RMDP server operating on the sender to receive file(s) distributed by the sender.

Listener: A listener is a passive receiver that does not generate any communication packets and therefore, may not be reliable. Hence, it listens but does not participate in the session.

Packet: The unit of data sent across a network. Packet is a generic term used to describe a unit of data at any layer of the Open Systems Interconnect (OSI) protocol stack, but it is most correctly used to describe application layer data units (“application protocol data unit”, APDU).

Application Protocol Data Unit (APDU): A packet of data exchanged between two application programs across a network. This is the highest level view of communication in the OSI seven layer model and a single packet exchanged at this level may actually be transmitted as several packets at a lower layer as well as having extra information (headers) added for routing etc.

Silently Discard: This means the implementation discards the packet without further processing. The implementation SHOULD provide the capability of logging the error, and SHOULD record the event in a statistics counter.

Session: A lasting connection between an RMDP server and an RMDP client, usually involving the exchange of many packets between the RMDP server and the RMDP client, the many packets making up a file. A session is typically implemented as a layer in a network protocol (e.g. telnet, FTP). In the case of protocols where there is no concept of a session layer (e.g. UDP) or where sessions at the session layer are generally very short-lived (e.g. HTTP), virtual sessions are implemented by having each exchange between the RMDP server and the RMDP client include some form of cookie which stores state (e.g. a unique session ID, information about the user's preferences or authorization level, etc.).

Operation: An operation is defined as a set of continuously processed sessions that distribute a set of files to the plurality of receivers, plus the necessary initialization and configuration process to complete the sessions. In such an operation, not all of the receivers will necessarily receive copies of each of the files making up the set of files.

Session-level Multicast: Session-level multicast is the act of sending from a sender a message to multiple receivers using a single local transmission at the session layer. How the message is duplicated and transmitted to the receivers is depending on the underlying protocol layer implementation. Essentially, there are three types of implementations: (1) multicast through unicast, (2) multicast through broadcast, and (3) multicast through multicast.

Link-level Broadcast/Multicast: To achieve session-level packet data multicast (or broadcast) efficiently, the link level protocol should support either broadcast or multicast. This requires the packet duplication facility at either link level protocol or the packet switch that connect the sender and all the receivers.

Receiver NACK/ACK Aggregation: To achieve the reliability of data communication, the receiver must send ACK or NACK to the sender to confirm the communication state at some stage. Due to the characteristic of broadcast/multicast data communication, the number of NACK/ACK sent by the receivers is limited by the network bandwidth and the sender's processing capability. Some techniques are required to aggregate the receiver communication information into one NACK/ACK packet.

Feedback Implosion control: The feedback implosion problem happens when large a number of multicast receivers sends feedback to the sender at same time, which will most likely cause the reverse link congestion and/or the sender running out of processing capacity.

The following acronyms are used herein:

ATM—Asynchronous Transfer Mode

DHCP—Dynamic Host Configuration Protocol

FEC—Forward Error Correction

MFDS—Multicast File Distribution Service

MHCP—Multicast Host Configuration Protocol

PPP—Point to Point Protocol

PLR—Packet Loss Rate

RMDP—Reliable Multicast Distribution Protocol

TCP—Transmission Control Protocol

UDP—User Datagram Protocol

### DETAILED DESCRIPTION OF THE DRAWINGS

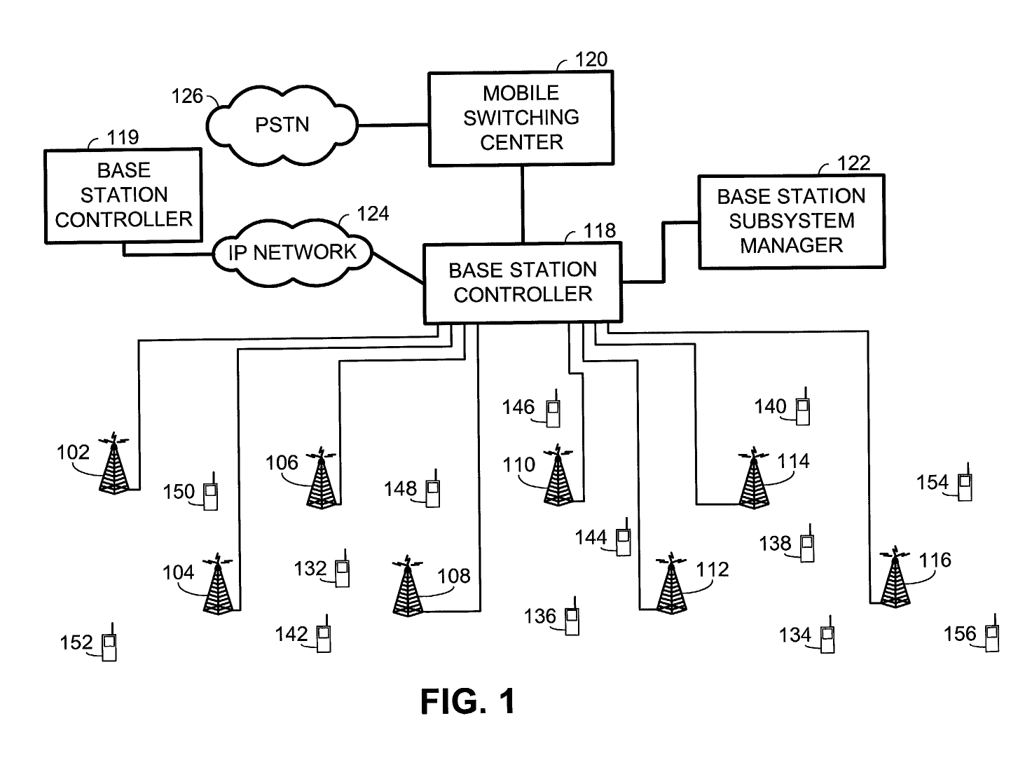

FIG. 1 is a system diagram illustrating a portion of a cellular wireless communication system in which the present invention is employed to distribute software to network infrastructure elements. In the system of FIG. 1, a sender performs multicast distribution of files to a plurality of receivers. The portion of the wireless communication system illustrated includes base stations 102, 104, 106, 108, 110, 112, 114, and 116. Each of the base stations 102-116 supports wireless communications within a respective cell. Each cell may be subdivided into a plurality of sectors with the base station, e.g., base station 102, supporting wireless communications within the respective sectors. The base stations 102-116 provide wireless communications support for a plurality of wireless subscriber units 132-156.

The base stations 102-116 couple to a base station controller (BSC) 118. The BSC 118 couples to a mobile switching center (MSC) 120. The MSC 120 is also referred to as a mobile telephone exchange, in some embodiments. The MSC 120 couples to the Public Switched Telephone Network (PSTN) 126 and services calls between the wireless subscriber units 132-156 and terminals coupled to the MSC 120 via the PSTN 126. The BSC 118 also couples to an IP network 124 and may service packet data communications between the wireless subscriber units 132-156 and devices coupled to the BSC 118 via the IP network 124, e.g., web sites coupled via the Internet, data terminals, etc. The BSC 118 may also couple to another BSC 119 via the IP network 124.

For simplicity in illustration, additional elements of the wireless communication system are not shown. The wireless communication system may include additional base stations coupled to the BSC 119, may include additional BSCs, may include additional base stations, and does include additional network elements that are known in the art. In the described embodiment, the wireless communication system services a Metropolitan Service Area (MSA) and includes hundreds, if not thousands, of base stations.

A base station manager (BSM) 122 also couples to the base station controller 118. According to the present invention, the BSM 122 acts as sender to multicast a set of files to the plurality of base stations 102-116 that act as receivers. In performing this operation, for each file that makes up the set of files, the BSM 122 initiates a multicast operation with each of a plurality of base stations 102-116 that requires a copy of the file. Once the multicast initiation is complete, the base stations, e.g., 102-116, prepare to receive the file. The BSM 122 then multicasts the file, data packet by data packet, to the base stations 102-116 via the BSC 118. The base stations 102-116 receive the data packets and reassemble the data packets to create local copies of the file. The base stations 102-116 may then execute or store the file to complete the software updates.

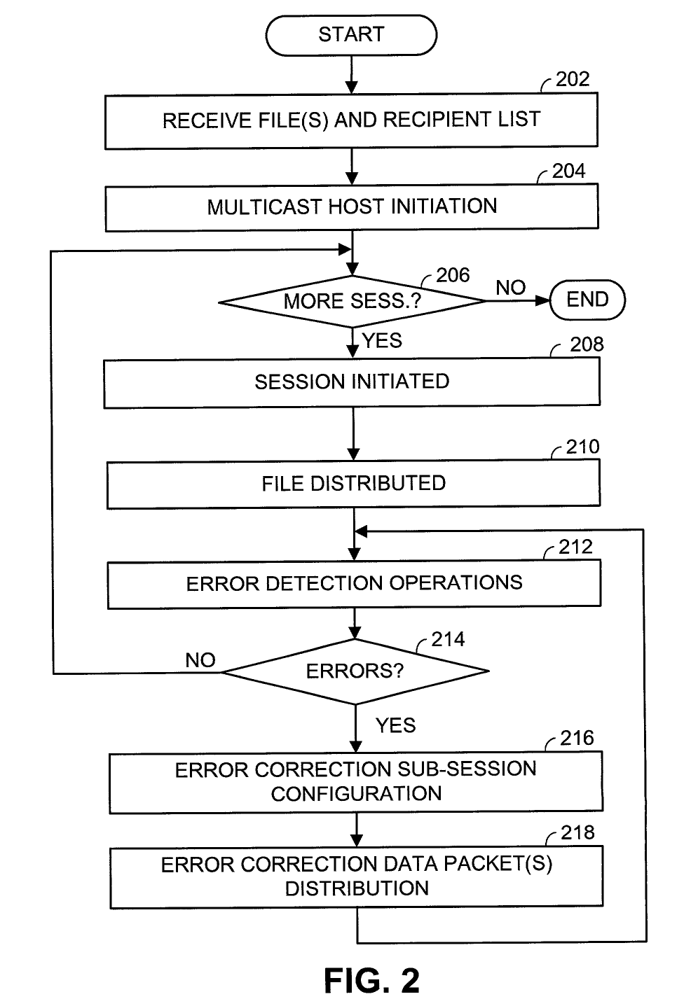

During the multicast operations, not all base stations 102-116 may correctly receive all data packets that make up the file and are therefore not able to reassemble the data packets to create the local copy of the files. Thus, the BSM 122 queries each of the base stations 102-116 to determine whether the base stations 102-116 received all data packets error free. Each of the base stations 102-116 reports to the BSM 122, indicating either that all data packets were received error free, or that errors occurred during the multicast operation. If errors did occur during the multicast operation, the reporting base station indicates to the BSM 122 (via the BSC 118) the data packets that were not received correctly. The BSM 122 then initiates and performs one (or more) multicast sub-sessions to complete the file download session by multicasting the data packets that were not correctly received. These actions are then repeated for each additional file of the set of files. The operations of the present invention will be described in more detail with reference to FIGS. 2, 4, 5, 9, and 10.

According to another aspect of the present invention, a BSM 122 coupled to one BSC 118, transmits data packets in a multicasting operation that pass through a plurality of BSCs, e.g., BSC 118 and BSC 119. Both of the BSCs 118 and 119 then pass the data packets to coupled base stations. Thus, in the embodiment, the BSC 119 serves as a “packet switch” and “packet replicator” in passing the data packets to base stations coupled thereto.

Further, in another embodiment of the present invention, the BSM 122 multicasts a file to wireless communication network elements other than base stations. For example, the BSM 122 may be a sender and each of the BSCs 118 and 119 may be receivers. In this embodiment, the BSM 122 establishes a multicast session with the BSCs 118 and 119, transmits files to the BSCs 118 and 119, and performs error operations to ensure that the BSCs 118 and 119 received the files correctly.

FIG. 2 is a logic diagram generally illustrating operation according to the present invention. The operation of FIG. 2 will be described with particular reference to the network infrastructure components of FIG. 1. Operation commences when the BSM operator requests that a set of file(s) be multicast to a plurality of receivers (base stations 102-116) (step 202). In response to this request, the sender (BSM 122) starts multicast host initiation (step 204). During multicast host initiation, the sender (BSM 122) interacts with each of the receivers (base stations 102-116) to prepare the base stations 102-116 to be able to join the multicast data distribution sessions.

Once the multicast host initiation is complete, a determination is made as to whether or not more sessions require servicing (step 206). Generally speaking, a session is performed for each file of the set of files to be distributed and only a single file is distributed during each session. Further, each file is associated with a particular set of receivers. Thus, each session may have a unique set of receivers for a corresponding file. However, in some embodiments, all files are associated with all receivers. Upon a first occurrence of step 206, at least one session is yet to occur. When all sessions have been completed, however, from step 206, operation ends.

If a session is to commence, operation proceeds to step 208 where the sender (BSM 122) initiates the multicast session (step 208). In initiating the multicast session, the file to be multicast is written to a binary buffer and a bit vector that represents the plurality of receivers (base stations 102-116) is created. A session status table is also created that is used to track the progress of the session. A session configuration packet is then constructed according to the parameters of the session and multicast to the plurality of receivers.

Then, best efforts are used to transmit all data packets comprising the session file to the receivers (base stations 102-116) (step 210). After all data packets have been multicast by the sender (BSM 122) to the receivers (base stations 102-116), error detection is performed by the sender (BSM 122) via interaction with the receivers (base stations 102-116) (step 212) to determine whether all data packets were successfully received by each receiver (base stations 102-116).

If no errors are detected, as determined at step 214, operation returns to step 206 where it is determined if an additional session will be initiated. However, if the receiver (BSM 122) detects errors, based upon reporting by the receivers (base stations 102-116), the sender (BSM 122) performs an error correction sub-session configuration (step 216). The sender (BSM 122) then multicasts the error correction data packets to the receiver(s) (at least one of the base stations 102-116) (step 218). Operation then proceeds to step 212 where error detection is performed for the remaining receivers (base stations 102-116) that were part of the multicast group.

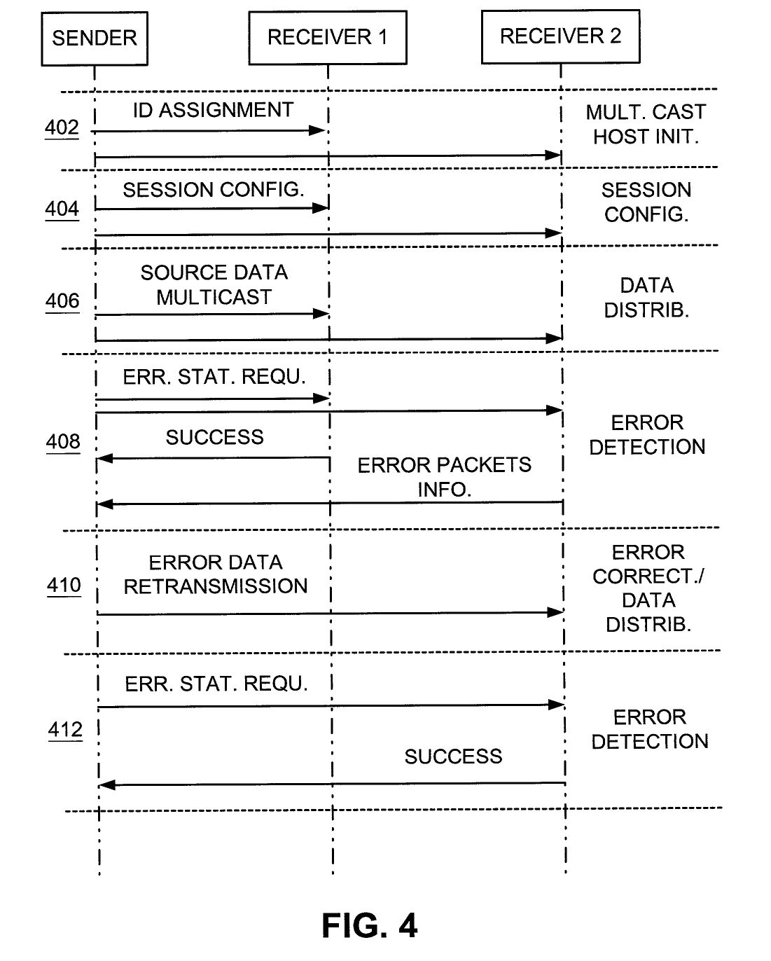

Error detection will be described in more detail with reference to FIGS. 4, 5, 9, and 10. Generally speaking however, the sender (BSM 122) and the receivers (base stations 102-116) interact such that the sender determines which data packets must be resent to which receivers. The sender (BSM 122) then creates an error correction sub-session to re-send the required data packets to the error-reporting receivers via multicast means (at least some of the base stations 102-116). Error detection and correction are then performed for the sub-session.

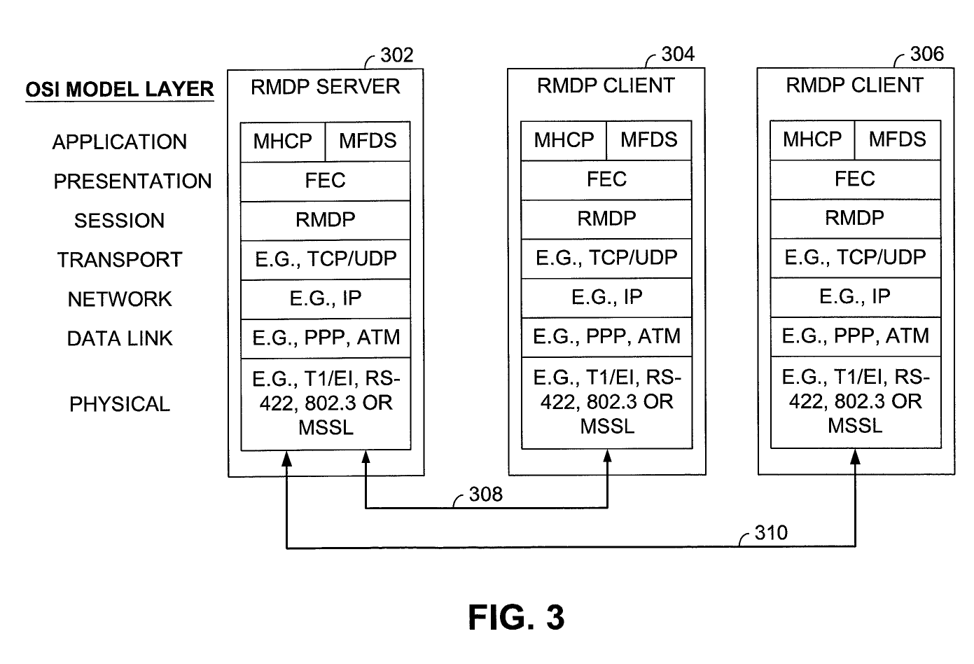

FIG. 3 is a block diagram illustrating how the functional components of software protocols constructed according to the present invention reside within the OSI (Open Systems Interconnect) reference model. With particular reference to the system of FIG. 1 and the operations of FIG. 2, the RMDP server 302 is instantiated upon the BSM 122. Further, the RMDP clients 304 and 306 are instantiated upon the base stations, base stations 102 and 104, for example. Of course, an RMDP client would be instantiated on each other of the base stations 106-116 as well.

With particular reference to the RMDP server 302, the MHCP and the MFDS both reside at the application layer of the OSI model. The MFDS is the interface between the user application and the protocol suite. The input from the user, i.e. a set of files and the set of receivers identified by network address, is received by MFDS. MFDS will create an operation which consists of one or more multicast sessions according to the user input, and complete the sessions with the use of RMDP. MFDS only accept user input at the RMDP server side. At the client side, MFDS shall interface to a file system to achieve the desired result. MFDS is responsible to start, maintain, and terminate a multicast distribution operation, which contains multicast host initialization and multiple multicast distribution sessions.

The MHCP is an application level protocol, which is used for clients to obtain their Multicast Host ID according to their network address. It operates similarly to the manner in which the Dynamic Host Configuration Protocol (DHCP) operates in the wired Internet model. This Multicast Host ID assignment process happens at very beginning of the Multicast File Distribution Services operation. The Multicast Host ID is the fundamental technique for the multicast membership and group control, which achieve higher efficiency and robustness. MHCP is responsible for the multicast host initialization within a multicast distribution operation.

FEC (Forward Error Correction) resides at the presentation layer of the OSI model and is a data presentation technique. Given a set of source data, the sender will send redundant encoded data, which allow the receiver to reconstruct up to a certain number of missing packets. The sender constructs encoded data that contains redundant packets from the source data before start of the communication process. The receiver can extract the source data from the available packets once sufficient packets are received. The use of FEC is optional. It is required only if the PLR is high or the reverse link is expensive. If FEC is required, MFDS must starts the file distribution session with FEC flag enabled and pass the FEC encoded file data to RMDP.

The RMDP resides at the session layer of the OS T model and is the core protocol layer of Multicast File Distribution Services. RMDP is a session layer protocol, which is responsible for starting, configuration, maintaining, and terminating a non-real-time, session-level reliable file distribution session. Each file (or a block of continuous binary stream) multicast distribution is considered as a session by RMDP. Each RMDP session must contain one or more sub-sessions for retransmission of error packets if missing packets are discovered during the error detection and signaling phase. RMDP is responsible for a single multicast distribution session and its error-correction sub-sessions. An operation of MFDS is comprised of a set of session and the required initialization process, such as multicast host ID assignment. For each RMDP client, the multicast host ID is unique throughout the operation. Therefore, only one multicast host ID assignment is required for each RMDP client who will participate one or more multicast sessions within an operation.

The remaining components of the RMDP server 302 protocol suite are known. For example, the transport layer of the OSI model may be satisfied using the TCP/UDP protocols, the network layer may be satisfied using the IP protocol, the data link layer may be satisfied using the PPP or ATM protocols, and the physical layer may be satisfied using any various physical layer protocol, e.g., T1/E1, RS-422, IEEE 802.3, MSSL, etc. However, the MFDS protocol suite requires that the underlying protocols provide broadcast and/or multicast support. Such support usually exists in the link layer and/or the physical layer.

The RMDP server 302 interfaces with the RMDP clients 304 and 306 via respective physical links 308 and 310. The physical links may be executed via a private network of the wireless communication system service provider, via a public network, or via a combination of private and public networks. The RMDP clients 304 and 306 include components of the OSI model that are analogous to the components described with reference to the RMDP server 302.

The RMDP server 302 exchanges packets with the RMDP clients 304 and 306. Essentially, there are only three types of packet used the protocol suite. The types of packets include control packets, data packets, and communication packets. The control packets and the data packets are sent from RMDP server 302 to RMDP clients 304 and 306. The communication packets are sent from RMDP client to RMDP server.

The control packets are generated only by the RMDP server 302, and are used for distributing session control information from the RMDP server 302 to the RMDP clients 304 and 306. The RMDP server 302 may also use the control packets to control the protocol state transition for any subset of RMDP clients 304 and 306. Control Packets can be generated at session start and during the configuration phase, the data distribution phase, and the error detection and the signaling phase. The MHCP server also uses this type of packet.

The data packets are generated only by RMDP server 302, and are used for distributing data from the RMDP server 302 to the RMDP clients 304 and 306. The data packets also provide support for NULL data packets, which may be used to fill quiescent intervals of data transmission during data distribution operations, if necessary.

Communication packets are generated only by RMDP clients 304 and 306, and are used for communicating state and signaling session status or error information to the RMDP server 302. Communication packets are generated as a consequence of the arriving stream of packets from the RMDP server 302 and the current protocol state of the client.

FIG. 4 is a message flow diagram illustrating operation according to the present invention. During multicast host initiation 402, the sender transmits an ID assignment to each of the receivers. Then, during the session configuration 404, the sender sends a session configuration message to each of the receivers.

With the session configuration complete, the sender multicasts the file to the receivers during data distribution operations 406. With all data packets for the file transmitted to the receivers, the sender initiates error detection 408 by sending error status requests to each of the receivers. Each of the receivers responds to the sender with either a success response (ACK) or an error packets information response (NACK). As is shown explicitly in FIG. 4, receiver 1 responds with a success response (ACK) while receiver 2 responds with an error packets information response in which receiver 2 identifies the packets it did not successfully receive.

With the error detection complete, the sender then retransmits required data that was not received by the receivers during the error correction/data distribution operations 410. After error correction operation is complete, the sender again sends an error status request to each receiver still requiring data. If all receivers have successfully received the data, they will report with a successful (ACK) response.

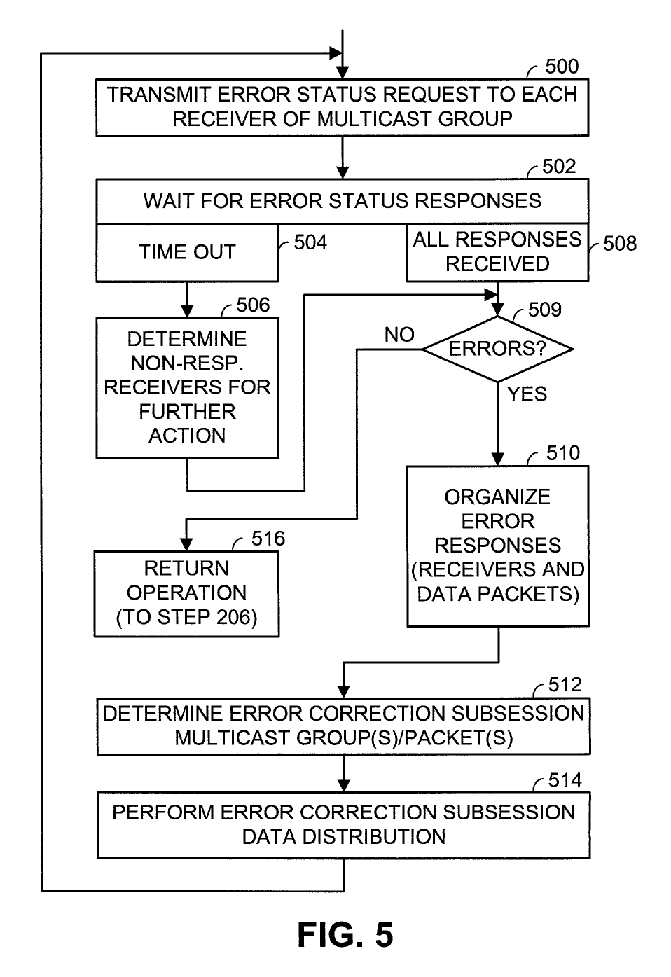

FIG. 5 is a logic diagram illustrating error correction according to the present invention. The flow illustrated in FIG. 5 provides an alternative to the flow described with reference to FIG. 2 and would be initiated after step 210 of FIG. 2 and in lieu of steps 212-218. The activity commences with the sender sending an error status request to each receiver of a corresponding multicast group (step 500). The sender then waits for error status responses to be returned from the plurality of receivers (step 502). When the sender receives all responses (step 508), it determines whether any errors resulted from the error correction sub-session (step 509). If no errors resulted, flow returns (to step 206 of FIG. 2). If errors have resulted from the error correction sub-session, the sender creates another error correction sub-session (step 510).

Not all receivers that were initialized may respond during a set waiting period. In such case, a time out occurs (step 504) and the sender determines which receivers did not respond (step 506). Then, flow proceeds to step 509.

Once the sender has organized the requirements of its error data retransmission, it determines at least one error correction sub-session and the data packet(s) required for transmission to each receiver (step 512). The sender then performs error correction sub-session configuration and data distribution for the group (step 514). Once the distribution is complete, flow returns to step 500 where the sender requests an error status response on a per-group basis. These steps are repeated for each error correction sub-session until all errors have been reconciled for the session.

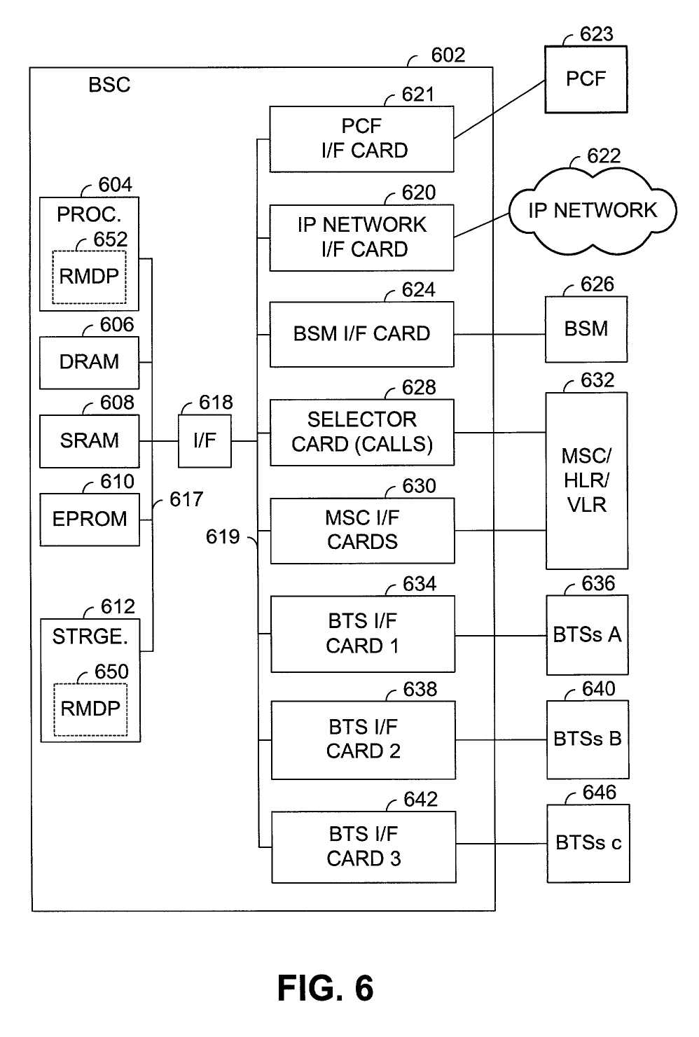

FIG. 6 is a block diagram illustrating the components of a base station controller (BSC) 602 that operates according to the present invention as a receiver. The structure and operation of BSCs is generally known. The BSC 602 services both circuit switched and packet switched operations. In some cases, the BSC 602 is called upon to convert data between circuit switched and data switched formats, depending upon the types of equipment coupled to the BSC 602. The components illustrated in FIG. 6, their function, and their interconnectivity is generally known and may vary without departing from the teachings of the present invention.

The BSC 602 includes a processor 604, dynamic RAM 606, static RAM 608, EPROM 610 and at least one data storage device 612, such as a hard drive, optical drive, tape drive, etc. These components intercouple via a local bus 617 and couple to a peripheral bus 619 via an interface 618. Various peripheral cards couple to the peripheral bus 619. These peripheral cards include an IP network interface card 620, a packet control function (PCF) interface card 621, a base station manager card 624, at least one selector card 628, a MSC interface card 630, and a plurality of BTS interface cards 634, 638 and 642.

The IP network interface card 620 couples the BSC 602 to an IP network 622. The PCF interface card 621 couples the BSC 602 to a PCF 623. The base station manager interface card 624 couples the BSC 602 to a Base Station Manager 626. The selector card 628 and MSC interface card 630 couple the BSC 602 to the MSC/HLR/VLR 632. The BTS interface cards 634, 638, and 642 couple the BSC 602 to base stations served by Base station Transceiver Subsystems (BTSs) 636, 640, and 646, respectively.

In the embodiment of FIG. 6, the BSC 602 executes software instantiating the RMDP client protocol. In such case, RMDP client software instructions 650 are loaded into storage 612. Then, the RMDP client software instructions 650 are downloaded to the processor 604 (and DRAM 606) as RMDP client software instructions 652 where they are executed by the processor 604. In this fashion, the BSC 604 performs the operations described herein that instantiate the RMDP client.

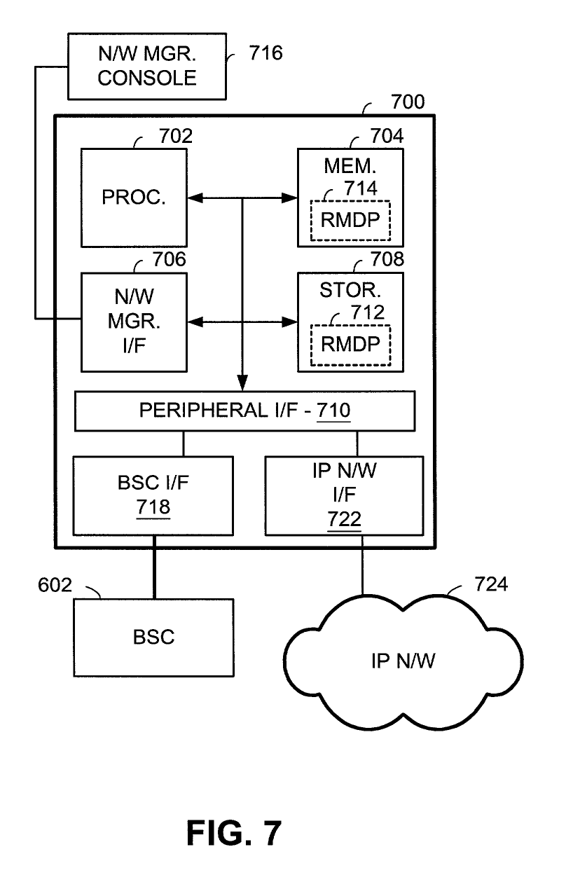

FIG. 7 is a block diagram illustrating the components of a base station manager 700 that operates according to the present invention as sender. The BSM 700 may be general-purpose computer that has been programmed and/or otherwise modified to perform the particular operations described herein. However, the BSM 700 may be specially constructed to perform the operations described herein. The BSM 700 instantiates the RMDP server described with reference to FIG. 3. The BSM 700 performs additional functions as well that are generally known in the art.

The BSM 700 includes a processor 702, memory 704, a network manager interface 706, storage 708 and a peripheral interface 710, all of which intercouple via a processor bus. The processor 702 may be a microprocessor or another type of processor that executes software instructions to accomplish programmed functions. The memory 704 may include DRAM, SRAM, ROM, PROM, EPROM, EEPROM, or another type of memory in which digital information may be stored. The storage 708 may include magnetic disk storage, magnetic tape storage, optical storage, or any other type of device, which is capable of storing digital instructions and data.

The network manager interface 706 couples to a network manager console 716. The network manager console 716 may be a keypad/display or may be a more complex device, such as a personal computer, which allows the manager to interface with the BSM 700. However, the network manager may interface with the BSM 700 using other techniques as well, e.g., via a card coupled to the peripheral interface 710.

The peripheral interface 710 couples to a BSC interface 718 and to an IP network interface 722. The BSC interface 718 couples the BSM 700 to a BSC 602. The IP network interface 722 couples the BSM 700 to an IP network 724, e.g., a combination of the Internet, Intranets, LANs, WANs, etc.

RMDP server software instructions 712 are loaded into the storage 708 of the BSM 700. Upon their execution, at least some of the RMDP server software instructions 712 are downloaded into memory 704 and/or the processor 702 (as RMDP server software instructions 714). The processor 702 then executes the RMDP server software instructions 714 to cause the BSM 700 to perform the operations of the RMDP server. The programming and operation of digital computers is generally known. Thus, the manners in which the processor 702 and the other components of the BSM 700 perform these operations are not further described herein.

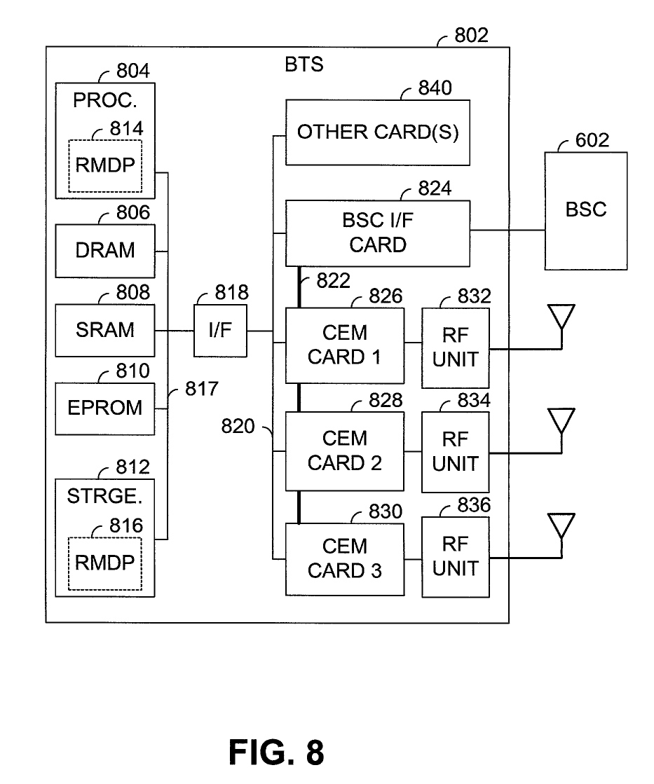

FIG. 8 is a block diagram illustrating the components of a base station 802 that operates according to the present invention as a receiver. The base station 802 supports the CDMA operating protocol, e.g., IS-95A, IS-95B, IS-2000, and/or various 3G and 4G standards. However, in other embodiments, the base station 802 supports other operating standards.

The base station 802 includes a processor 804, dynamic RAM 806, static RAM 808, Flash memory, EPROM 810 and at least one data storage device 812, such as a hard drive, optical drive, tape drive, etc. These components intercouple via a local bus 817 and couple to a peripheral bus 819 via an interface 818. Various peripheral cards couple to the peripheral bus 819. These peripheral cards include a BSC interface card, which couples the base station 802 to a BSC 602. Channel Element Modules (CEMs) 826, 828, and 830 couple to RF units 832, 834, and 836, respectively. The RF units 832, 834, and 836 couple to antennas and support wireless communication between the base station 802 and wireless subscriber units (not shown). The base station 802 may include other cards as well.

RMDP client software instructions 816 are stored in storage 812. The RMDP client software instructions 816 are downloaded to the processor 804 and/or the DRAM 806 as RMDP client instructions 814 for execution by the processor 804.

While the RMDP server software instructions and the RMDP client software instructions are shown to reside within storage contained in BSCs, BSMs and base stations, the RMDP server software instructions and the RMDP client software instructions may be loaded onto portable media such as magnetic media, optical media or electronic media. Further, the RMDP server software instructions and the RMDP client software instructions may be electronically transmitted from one computer to another across a data communication path. These embodiments of the software instructions are all within the spirit and scope of the present invention.

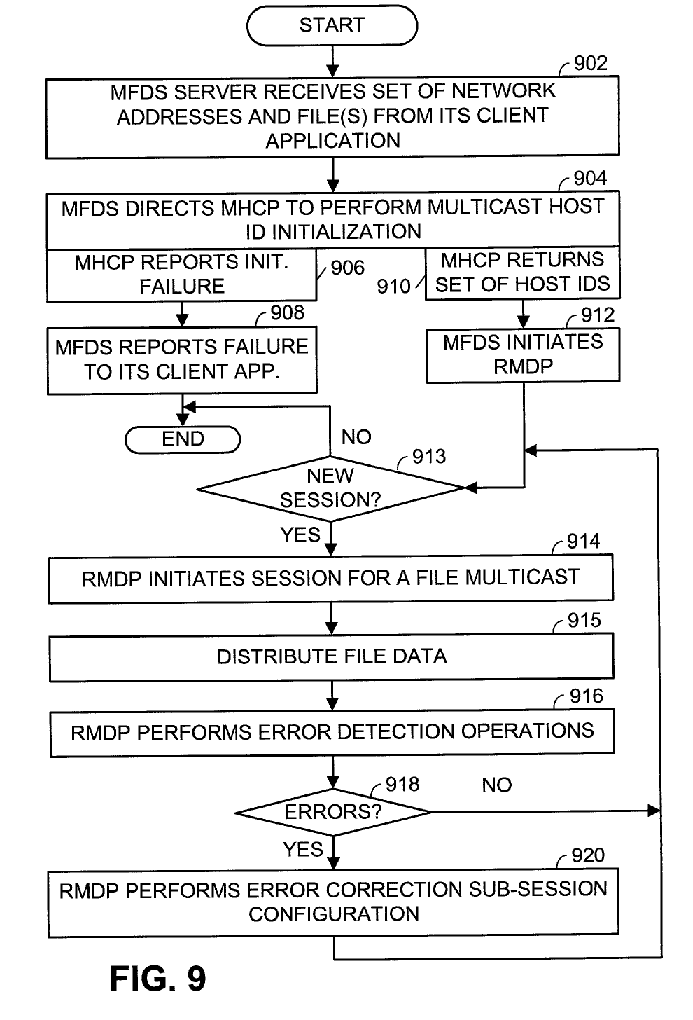

FIG. 9 is a logic diagram illustrating the interaction of RMDP server components according to the present invention. This description of FIG. 9 should be considered in conjunction with the description and illustrations of FIG. 3. Operation commences when the MFDS sever receives a set of network addresses and a file or set of files from its client application (step 902). The client application calling the MFDS is another process executing on the sender hosting the MFDS server, e.g., BSC, BSM, etc., or via a process coupled to the sender. The MFDS server directs the MHCP server to perform multicast host ID initialization for the RMDP clients identified (step 904). If the MHCP server reports an initialization failure (step 906), the MFDS reports the failure to its client application (step 908) and operation ends.

However, if the MHCP server returns a set of host IDs to the MFDS server (step 910), the MFDS server then initiates the RMDP server (step 912). Next, a determination is made as to whether a new session is required (step 913). Of course upon the first consideration, a new session will be required. However, on subsequent considerations, new sessions will not be required and operation will end from step 913.

If a new session is required, the RMDP server then initiates a multicast session for a selected file that was received by the MFDS server from its client application (step 914). The RMDP server then distributes the data that makes up the file to the plurality of receivers in the multicast group (step 915). The RMDP server then performs error detection (step 916). If no errors occurred during the multicast, as determined at step 918, flow returns to step 913. However, if errors did result in the multicast operation, the RMDP server performs error correction sub-session configuration (step 920). From step 920, flow returns to step 913.

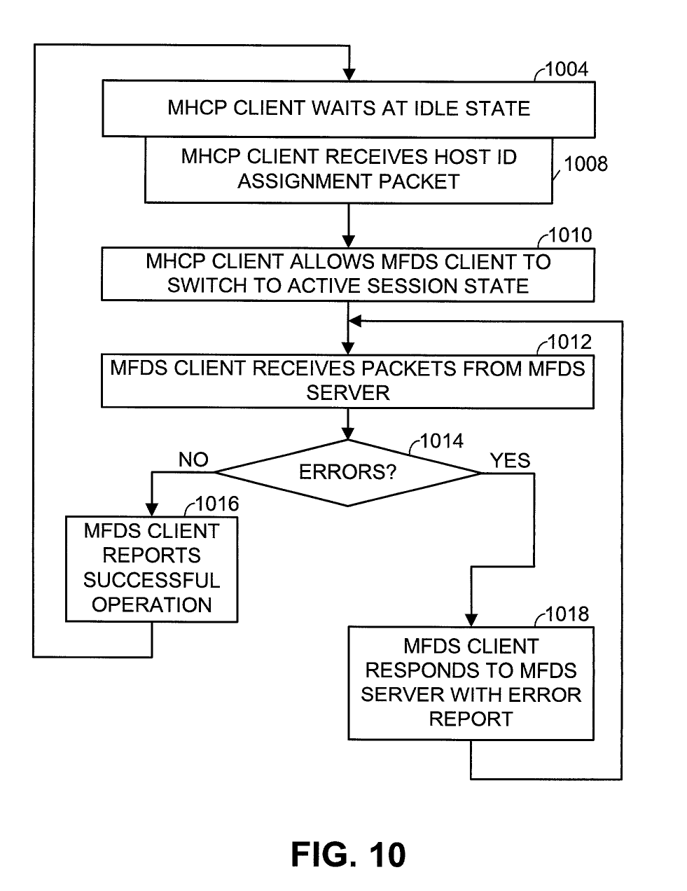

FIG. 10 is a logic diagram illustrating the interaction of RMDP client components according to the present invention. At idle state, the MFDS client invokes the MHCP client (step 1002). The MHCP client then waits in an idle state for an assignment from an MHCP server (step 1004). Next, the MHCP client receives a host ID assignment from a MHCP server to begin a distribution operation (step 1008).

The MHCP client then allows the MFDS client to switch to a session idle state (step 1010), in which state the RMDP client awaits packets from the RMDP server. The RMDP client then receives packets from the RMDP server (step 1012). If the RMDP client successfully receives all packets from the RMDP server (as determined at step 1014), the RMDP client reports a successful session completion to the RMDP server in response to an error status request (step 1016).

However, if the MFDS client did not successfully receive all packets from the MFDS server (as determined at step 1014), the MFDS client responds to the MFDS server with an error report, indicating the data packets it did not successfully receive (step 1018). Flow then returns to step 1012 where the MFDS client awaits the additional packets during an error correction sub-session.

The invention disclosed herein is susceptible to various modifications and alternative forms. Specific embodiments therefor have been shown by way of example in the drawings and detailed description. It should be understood, however, that the drawings and detailed description thereto are not intended to limit the invention to the particular form disclosed, but on the contrary, the invention is to cover all modifications, equivalents and alternatives falling within the spirit and scope of the present invention as defined by the claims.

1. In a wireless communication system including a plurality of wireless communication system network components intercoupled by a wired network, a method for distributing a file from a network component acting as a sender to a plurality of network components acting as receivers, the method comprising:
the sender establishing a multicast session with the plurality of receivers;
the sender subdividing the file into a plurality of data packets;
the sender multicasting the plurality of data packets to the plurality of receivers;
at least some of the plurality of receivers failing to correctly receive all of the plurality of data packets;
the at least some of the plurality of receivers failing to correctly receive all of the plurality of data packets error reporting to the sender of the plurality of data packets; and
the sender transmitting a plurality of previously incorrectly received data packets of the plurality of data packets to the at least some of the plurality of receivers.

2. The method of claim 1, wherein the sender is a base station manager.

3. The method of claim 1, wherein the receivers are base station controllers.

4. The method of claim 1, wherein the receivers are base stations.

5. The method of claim 4, wherein:
the base stations operate according to a code division multiple access wireless operating standard; and
the base stations load the file onto a plurality of processing cards contained within the base stations.

6. The method of claim 1, wherein:
the plurality of receivers comprise a group of network components requiring a software update; and
the file comprises the software update.

7. The method of claim 1, wherein error reporting to the sender comprises:
the sender transmitting an error status request to the plurality of receivers; and
at least one of the plurality of receivers responding to the sender with an error message.

8. The method of claim 1, wherein error reporting to the sender comprises:
the sender sends an error status request to a first plurality of receivers during a first time period;
the sender sends an error status request to a second plurality of receivers during a second time period; and
wherein the first time period is different from the second time period.

9. The method of claim 1, wherein transmitting a plurality of previously incorrectly unreceived data packets of the plurality of data packets to the at least some of the plurality of receivers comprises:
the sender determining a subset of receivers that failed to correctly receive all of the plurality of data packets;
the sender of the file determining a corresponding set of data packets that were not previously incorrectly received by the subset of receivers; and
the sender of the file multicasting the corresponding set of data packets to the subset of receivers.

10. A system for distributing a file within a wireless communication network, the system comprising:
a server network component of the wireless communication network, the server network component comprising:
a processor;
a memory coupled to the processor; and
a network interface coupled to the processor;
a plurality of receiver network components of the wireless communication network, each of the receiver network components comprising:
a processor;
a memory coupled to the processor; and
a network interface coupled to the processor; and
a plurality of software instructions executable by the sender network component and the plurality of receiver network components, the plurality of software instructions comprising:
a first set of sender software instructions that, when executed by the processor of the sender, causes the sender to establish a multicast session with the plurality of receiver network components;
a first set of receiver software instructions that, when executed by a receiver, causes the receiver to interact with the sender to join the multicast session;
a second set of sender software instructions that, when executed by the processor of the sender, causes the sender to subdivide the file into a plurality of data packets;
a third set of sender software instructions that, when executed by the processor of the sender causes the sender to multicast the plurality of data packets to the plurality of receivers;
a second set of receiver instructions that, when executed by the processor of a receiver that fails to correctly receive all of the plurality of data packets, causes the receiver to error report to the sender; and
a fourth set of sender software instructions that, when executed by the processor of the sender, causes the sender to transmit a plurality of incorrectly received data packets of the plurality of data packets to the receiver that fails to correctly receive all of the plurality of data packets.

11. The system of claim 10, wherein the sender is a base station manager.

12. The system of claim 10, wherein the receivers are base station controllers.

13. The system of claim 10, wherein the receivers are base stations.

14. The system of claim 13, wherein:
the base stations operate according to a code division multiple access wireless operating standard; and
the base stations load the file onto a plurality of processing cards contained within the base stations.

15. The system of claim 10, wherein:
the plurality of receivers comprise a group of network components requiring a software update; and
the file comprises the software update.

16. The system of claim 10, further comprising:
a fifth set of sender software instructions that, when executed by the processor of the sender, causes the sender to transmit an error status request to the plurality of receivers; and
a sixth set of sender software instructions that, when executed by the processor of the sender, causes the sender to receive an error status response from at least some of the plurality of receivers.

17. The system of claim 11, wherein the fifth set of sender software instructions further causes:
the sender to transmit an error status request to a first plurality of receivers during a first time period;
the sender to transmit an error status request to a second plurality of receivers during a second time period; and
wherein the first time period is different from the second time period.

18. The system of claim 10, further comprising a fifth set of sender instructions that, when executed by the processor of the sender, causes the sender to:
determine a subset of receivers that failed to correctly receive all of the plurality of data packets;
determine a corresponding set of data packets that were not correctly received by the subset of receivers; and
multicast the corresponding set of data packets to the subset of receivers.

19. A system for distributing a file within a wireless communication network, the system comprising:
a server protocol suite operating on a sender component of the wireless communication network;
a plurality of receiver protocol suites operating on a plurality of receiver network components of the wireless communication network, wherein each of the plurality of receiver network components is communicatively coupled to the sender component;
wherein the server protocol suite causes the sender to establish a multicast session with the plurality of receiver network components;
wherein the receiver protocol suite causes the plurality of receivers to interact with the sender to join the multicast session;
wherein the server protocol suite causes the sender to subdivide the file into a plurality of data packets;
wherein the server protocol suite causes the sender to multicast the plurality of data packets to the plurality of receivers;
wherein the receiver protocol suite causes the plurality of receivers to error report to the sender; and
the server protocol suite causes the sender to transmit a plurality of incorrectly received data packets of the plurality of data packets to a receiver that fails to correctly receive all of the plurality of data packets.

20. The system of claim 19, wherein the sender is a base station manager.

21. The system of claim 19, wherein the receivers are base station controllers.

22. The system of claim 19, wherein the receivers are base stations.

23. The system of claim 22, wherein:
the base stations operate according to a code division multiple access wireless operating standard; and
the base stations load the file onto a plurality of processing cards contained within the base stations.

24. The system of claim 19, wherein:
the plurality of receivers comprise a group of network components requiring a software update; and
the file comprises the software update.

25. The system of claim 19:
wherein the server protocol suite causes the sender to transmit an error status request to the plurality of receivers; and
wherein the receive protocol suite causes each of the plurality of receivers to respond to the sender with an error status response.

26. The system of claim 19, wherein the server protocol suite causes the sender to:
transmit an error status request to a first plurality of receivers during a first time period;
transmit an error status request to a second plurality of receivers during a second time period; and
wherein the first time period is different from the second time period.

27. The system of claim 19, wherein the server protocol suite causes the sender to:
determine a subset of receivers that failed to correctly receive all of the plurality of data packets;
determine a corresponding set of data packets were not correctly received by the subset of receivers; and
multicast the corresponding set of data packets to the receivers comprising the subset of receivers that failed to correctly receive all of the plurality of data packets.
